(19) United States
(12) Patent Application Publication
(10) Pub. No.: US 2025/0038570 A1
(43) Pub. Date: Jan. 30, 2025

(54) SYSTEMS AND METHODS FOR CONTROLLING MULTIPLE-MICROGRID SYSTEMS

(71) Applicant: EdgeTunePower Inc., North Vancouver (CA)

(72) Inventors: Arman Ghasaei, North Vancouver (CA); Mohammad Reza Iravani, Toronto (CA)

(21) Appl. No.: 18/715,977

(22) PCT Filed: Dec. 12, 2022
(86) PCT No.: PCT/IB2022/062081

§ 371 Date: Jun. 3, 2024

Related U.S. Application Data
(60) Provisional application No. 63/289,089, filed on Dec. 13, 2021.
(60) Provisional application No. 63/427,987, filed on Nov. 25, 2022.

(51) Int. Cl. H02J 13/00

(52) U.S. Cl. CPC H02J 13/00036

(57) ABSTRACT

There are provided systems and methods for controlling multiple-microgrid systems, which include a control system having two or more primary controllers, each configured to be in communication with a corresponding microgrid (MG) and a corresponding microgrid circuit breaker (MGCB) interposed between the MG and a feeder line of a multiple-microgrid system (MMG). The MG is connected to the feeder line at a point of common coupling. The control system also includes a secondary controller associated with the MMG. The secondary controller is configured to be in communication with the primary controllers, and also in communication with a multiple-microgrid system circuit breaker (MMGCB) interposed between the MMG and a transmission line. Furthermore, the control system includes a tertiary controller configured to be in communication with the secondary controller, one or more electrical utilities, and one or more utility circuit breakers (UCBs) each interposed between the corresponding utility and the transmission line.

### CROSS-REFERENCE TO RELATED APPLICATIONS

This application claims priority from U.S. Provisional Patent Application No. 63/289,089, filed on Dec. 13, 2021, which is incorporated herein by reference in its entirety. This application also claims priority from U.S. Provisional Patent Application No. 63/427,987, filed on Nov. 25, 2022, which is also incorporated herein by reference in its entirety.

### FIELD

The present specification relates to systems and methods for controlling electrical grid systems, and in particular to systems and methods for controlling multiple-microgrid systems.

### BACKGROUND

Electrical grid systems are used to transmit and distribute electricity. Such grid systems may connect sources that generate electrical energy to loads that consume that electrical energy. Examples of such sources may include photovoltaic or solar sources, wind-powered sources, hydro-electric sources, nuclear power plants, gas-fired power plants, and the like. Moreover, examples of loads may include electrical appliances, electric vehicles, factories, and the like.

### SUMMARY

According to an implementation of the present specification there is provided a control system for controlling one or more multiple-microgrid systems, the control system comprising: two or more primary controllers, each primary controller to be in communication with a corresponding microgrid (MG) and a corresponding microgrid circuit breaker (MGCB) interposed between the corresponding MG and a corresponding feeder line of a corresponding multiple-microgrid system (MMG), the MG connected to the feeder line at a point of common coupling (PCC); a secondary controller associated with the corresponding MMG, the secondary controller to be in communication with the one or more primary controllers, the secondary controller also to be in communication with a multiple-microgrid system circuit breaker (MMGCB) interposed between the MMG and a transmission line; and a tertiary controller to be in communication with: the secondary controller; one or more electrical utilities; and one or more utility circuit breakers (UCBs) each corresponding to one of the one or more utilities, each UCB interposed between the corresponding utility and the transmission line.

The control system may further comprise: a further secondary controller associated with a further corresponding MMG, the further secondary controller to be in communication with one or more further primary controllers associated with the further corresponding MMG, the further secondary controller also to be in communication with a further multiple-microgrid system circuit breaker (further MMGCB) interposed between the further MMG and the transmission line; and wherein: the tertiary controller is to be in communication with the further secondary controller.

The secondary controller may be further to receive measurements of one or more operational parameters measured at the PCC.

The operational parameters may comprise one or more of voltage, current, and frequency in the feeder line at the PCC.

One or more of the MGs may each comprise one or more of a source to generate electrical energy, a load to consume electrical energy, and a battery energy store system (BESS) to store or release electrical energy.

One or more of the primary controllers, the secondary controller, and the tertiary controller may comprise processing hardware to execute machine-readable instructions embodying a state machine.

The processing hardware may comprise a programmable logic controller (PLC).

The state machine may be based on a discrete event model of one or more of: the one or more MGs, the one or more MGCBs, the MMG, the MMGCB, the one or more electrical utilities, and the one or more UCBs.

The state machine may be associated with one of the primary controllers associated with the corresponding MG; and the state machine may cover all possible events in the discrete event model of the corresponding MG.

When a given MGCB is open: the primary controller associated with the given MGCB may be to control a given MG associated with the given MGCB by controlling one or more of the source, the load, and the BESS associated with the given MG; and the secondary controller and the tertiary controller may not participate in controlling the given MG.

When two or more given MGCBs are closed and the associated given MMGCB is open, the secondary controller associated with the given MMGCB may be to: control the given primary controllers associated with the two or more given MGCBs to coordinate the operation of the given primary controllers; and receive measurements of operational parameters measured at the PCC.

When two or more given MGCBs are closed, the associated given MMGCB is closed, and the one or more UCBs are open: the secondary controller associated with the given MMGCB may be to: control the given primary controllers associated with the two or more given MGCBs; and receive measurements of operational parameters measured at the PCC; and the tertiary controller may be to: dictate one or more of the operational parameters at the PCC.

When two or more given MGCBs are closed, the associated given MMGCB is closed, and one or more of the UCBs are closed: the tertiary controller may be to: receive utility operating parameters from one or more of the utilities associated with the closed UCBs; communicate the utility operating parameters to the secondary controller; and dictate one or more of the operational parameters at the PCC; and the secondary controller associated with the given MMGCB may be to: control the given primary controllers associated with the two or more given MGCBs; and receive measurements of operational parameters measured at the PCC.

When two or more given MGCBs are closed, the associated given MMGCB is closed, the further MMGCB is closed, and the one or more UCBs are open: the secondary controller associated with the given MMGCB may be to: control the given primary controllers associated with the two or more given MGCBs; and receive measurements of operational parameters measured at the PCC; the further secondary controller may be to: control the given further primary controllers associated with the further corresponding MMG; and receive measurements of the operational parameters measured at the PCC; the tertiary controller may be to: control the secondary controller and the further secondary controller to coordinate the operation of secondary controller and the further secondary controller; and dictate one or more of the operational parameters at the PCC.

When two or more given MGCBs are closed, the associated given MMGCB is closed, the further MMGCB is closed, and one or more of the UCBs are closed: the tertiary controller may be to: receive utility operating parameters from one or more of the utilities associated with the closed UCBs; communicate the utility operating parameters to the secondary controller and the further secondary controller; control the secondary controller and the further secondary controller; and dictate one or more of the operational parameters at the PCC; the secondary controller associated with the given MMGCB may be to: control the given primary controllers associated with the two or more given MGCBs; and receive measurements of operational parameters measured at the PCC; the further secondary controller may be to: control the given further primary controllers associated with the further corresponding MMG; and receive measurements of the operational parameters measured at the PCC.

According to another implementation of the present specification there is provided a method of generating the state machine for one or more of the primary controller, the secondary controller, and the tertiary controller of the control system, the method comprising: generating a discrete event model of each of the components to be controlled by the state machine; combining the discrete event models of the components using a supervisory control theory (SCT) tool to generate a combined discrete event model; generating a control specification associated with the control of the components by the state machine; generating the state machine using the SCT tool based on the combined discrete event model and the control specification; and outputting the state machine.

The method may further comprise: before the generating the state machine: determining, using a synchronous product function of the SCT tool, whether the combined discrete event model is non-blocking; and if the determination is negative: generating a revised discrete event model of one or more of the components; and regenerating the combined discrete event model using the SCT tool based on the revised discrete event model.

The method may further comprise: before the outputting the state machine: determining whether the state machine is empty; and if the determination is affirmative: generating a revised discrete event model of one or more of the components; generating a revised combined discrete event model using the SCT tool based on the revised discrete event model; and regenerating the state machine using the SCT tool based on the revised combined discrete event model and the control specification.

The method may further comprise: before the outputting the state machine: determining, using a synchronous product function of the SCT tool, whether the state machine is non-blocking; and if the determination is negative: generating a revised control specification associated with the control of the components; and regenerating the state machine using the SCT tool based on the combined discrete event model and the revised control specification.

The method may further comprise: generating another discrete event model of each of corresponding components to be controlled by another state machine, the other state machine for another one of the one or more of the primary controller, the secondary controller, and the tertiary controller of the control system; combining the other discrete event models of the corresponding components using the SCT tool to generate another combined discrete event model; generating another control specification associated with the control of the corresponding components by the other state machine; generating the other state machine using the SCT tool based on the other combined discrete event model and the other control specification; determining, using a synchronous product function of the SCT tool, whether the state machine is non-conflicting with the other state machine; and if the determination is negative, one or more of: generating a revised control specification; and generating a revised other control specification.

### BRIEF DESCRIPTION OF THE DRAWINGS

Some example implementations of the present specification will now be described with reference to the attached Figures, wherein:

FIG. 1 shows a schematic representation of an example control system, in accordance with a non-limiting implementation of the present specification.

FIG. 2 shows a schematic representation of another example control system, in accordance with a non-limiting implementation of the present specification.

FIG. 3 shows a schematic representation of an example microgrid (MG), in accordance with a non-limiting implementation of the present specification.

FIG. 4 shows a flowchart of an example method, in accordance with a non-limiting implementation of the present specification.

FIGS. 5(a) and 5 (b) show example discrete event models, in accordance with a non-limiting implementation of the present specification.

FIG. 5(c) shows an example combined discrete event model, in accordance with a non-limiting implementation of the present specification.

FIG. 5(d) shows an example control specification, in accordance with a non-limiting implementation of the present specification.

FIG. 5(e) shows an example state machine, in accordance with a non-limiting implementation of the present specification.

FIGS. 5(f) and 5 (g) show other example discrete event models, in accordance with a non-limiting implementation of the present specification.

FIG. 5(h) shows another example control specification, in accordance with a non-limiting implementation of the present specification.

FIG. 5(i) shows another example state machine, in accordance with a non-limiting implementation of the present specification.

FIG. 5(j) shows yet another example discrete event model, in accordance with a non-limiting implementation of the present specification.

FIG. 5(k) shows yet another example control specification, in accordance with a non-limiting implementation of the present specification.

FIG. 5(l) shows yet another example state machine, in accordance with a non-limiting implementation of the present specification.

FIG. 6 shows a flowchart of another example method, in accordance with a non-limiting implementation of the present specification.

### DETAILED DESCRIPTION

Unless the context requires otherwise, throughout this specification the word “comprise” and variations thereof, such as, “comprises” and “comprising” are to be construed in an open, inclusive sense, that is as “including, but not limited to.”

As used in this specification, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

Some electrical grid systems may be organized or divided into smaller subparts. Electrical grid systems may also be described as “electrical grids” or “grids”, in short. Examples of such subparts of grids may include microgrids (MGs), two or more MGs connected to a common feeder line to form a multiple-microgrid system (MMG), and the like. In some examples, a MG may be able to continue to operate if disconnected or islanded from the rest of the grid. An example MG is described in greater detail in relation to FIG. 3.

Grids or grid subparts may have operational targets, such as reducing or minimizing downtime, maintaining operational parameters such as voltage and frequency in transmission or distribution lines, and maintaining the various grid components within their optimal or safe operating limits. Examples of grid components may include sources to generate electrical energy, loads that consume electrical energy, electrical energy storage systems, circuit breakers, and the like. In addition, grid operations are subject to dynamic conditions such as changes in the level of electricity consumption or generation, equipment malfunction, physical or environmental incidents (such as lighting strikes, downed power lines, and the like), cyber attacks, and the like.

Control systems may be used to coordinate and control the various components and subparts of a grid, and to respond to dynamic conditions to assist the grid or grid subparts in meeting their operational targets. Such control systems may receive information from or about some components or subparts of a grid, and send commands to some components or subparts of the grid to control and coordinate their operation. It is contemplated that in some examples, control systems may receive such information indirectly, for example via measurement devices such as meters and the like.

Some control systems rely on a manually-enumerated list of significant dynamic conditions or scenarios, and also manually-enumerated responses for such conditions. Dynamic in this context may refer to a change in the conditions, operations, or operational requirements demanded from, one or more components or portions of a grid. In some examples, dynamic may refer to, be based on, or take into consideration the speed of such changes. As the complexity and the number of components in a grid grows, the number of possible dynamic conditions may become very large. This, in turn, may make it impracticable or impossible to manually enumerate all possible dynamic conditions that may affect a grid. In addition, as the number of components and complexity of a grid increase, so does the likelihood that manually-enumerated lists will miss significant conditions and that manually-enumerated responses may give conflicting instructions to different components or subparts of a grid for at least some of the dynamic conditions.

In addition, some control systems rely on making predictions about significant dynamic conditions that may affect the grid, based on datasets of historical operation of that grid or similar girds, grid subparts, or components. As with most predictions, such predictions about dynamic conditions are subject to errors and uncertainties and often fail at addressing outlier conditions or edge cases. Furthermore, in case of some types of predictions, for example predictions generated by certain types of machine learning models, it may be difficult or impossible to review or audit how the predictions were arrived at to access the reliability or correctness of the predictions.

Moreover, some control systems rely on controllers that are electrically distant form the grid subparts and components they control, and depend upon real-time, computationally-intensive processing. The measure of electrical distance may be based on the length of conductor that connects two entities, for example the controller and the component to be controlled by that controller. The electrical distance and intensive computational demands may introduce or increase delay in the ability of such controllers to respond to dynamic conditions affecting a grid. FIG. 1 shows a schematic representation of an example control system 100 for controlling one or more MMGs. Control system 100 may also be referred to as “system 100”, in short. System 100 comprises two or more primary controllers 105-1 to 105-n, where n is a natural number greater than 1. System 100 also comprises a secondary controller 110-1 and a tertiary controller 115. System 100 may be used to control an example grid 120.

Grid 120 comprises a plurality of MGs, each corresponding to a primary controller. For example, grid 120 comprises a MG 125-1 associated with primary controller 105-1, and a MG 125-n associated with primary controller 105-n. There is a microgrid circuit breaker (MGCB) interposed between each microgrid and a feeder line 133 that connects together the various MGs. For example, MGCB 130-1 is interposed between MG 125-1 and feeder line 133, and MGCB 130-n is interposed between MG 125-n and feeder line 133. Each MGCB may be used to connect or disconnect its corresponding MG from feeder line 133. Each primary controller is to be in communication with its corresponding MG and MGCB. For example, primary controller 105-1 is to be in communication with MG 125-1 and MGCB 130-1, and primary controller 105-n is to be in communication with MG 125-n and MGCB 130-n.

A controller, such as a primary controller, to be in communication with another grid subpart (such as a MG) and or a component (such as MGCB) may also be described as the controller being configured to, adapted to, or capable of being in communication with those grid subparts or components. It is contemplated that being in communication may comprise being connected in a manner that is wired, wireless, or a combination of wired and wireless. In addition, it is contemplated that communication may comprise one-way communication, two-way communication, or both. Furthermore, it is contemplated that communication may comprise ongoing communication, intermittent communication, periodic communication, a-periodic or sporadic communication, the potential or ability to communicate if and when needed, and the like. In some examples, two entities that are in communication may be in direct communication. Such direct communication may reduce delay or errors in communications between those two entities. It is also contemplated that in some examples the communication between two entities may be indirect.

In FIG. 1, dashed lines are used to connect entities that are to be in communication with one another. Solid lines are used to show electrical connections between grid subparts or components.

MGs 125-1 to 125-n may be referred to collectively or generically as MGs 125, and primary controllers 105-1 to 105-1 me be referred to collectively or generically as primary controllers 105. MGs 125 are each connected to common feeder line 133 via their respective MGCBs at a point of common coupling (PCC) 135. As such, these MGs form a MMG 140-1. In FIG. 1, the three black circles between MGs 125-1 and 125-n are intended to indicate that MMG 140-1 may include additional MGs not shown in FIG. 1. PCC 135 may be considered as a point of functional delineation between the MG and the MMG. In other words, PCC 135 may be considered as a point in the grid where, operationally, each MG 125 presents its operational parameters (e.g. voltage, frequency, etc.) to the rest of MMG 140-1. It is also contemplated that in some examples, operational parameters may include level of power exchange with another component of the grid or grid subpart. While in FIG. 1 PCC 135 is depicted as being at a certain position on feeder line 133, it is contemplated that the PCC could also be another point or region along feeder line 133.

MMG 140-1 is connected to a transmission line 145 of grid 120. A MMG circuit breaker (MMGCB) is interposed between MMG 140-1 and transmission line 145. Control system 100 comprises secondary controller 110-1, which is associated with MMG 140-1. Controller 110-1 is to be in communication with primary controllers 105. Controller 110-1 is also to be in communication with MMGCB 150-1. Moreover, in some examples, secondary controller 110-1 may also receive measurements regarding the operational parameters at PCC 135. Examples of such operational parameters may include voltage, current, frequency, and the like in feeder line 133 at PCC 135. It is also contemplated that in some examples, operational parameters may include power exchange between the MMG and another grid component or subpart, such as the transmission line and the like.

While FIG. 1 shows a dashed line between controller 110-1 and PCC 135 indicating that controller 110-1 may receive information or measurements regarding operational parameters at PCC 135, it is contemplated that in some examples controller 110-1 need not be in direct communication with the PCC. In some such examples, controller 110-1 may receive the measurements of the operational parameters at PCC indirectly, i.e. from another component. Moreover, in some other such examples, controller 110-1 need not receive measurements of operational parameters at the PCC. While FIG. 1 shows system 100 as having one secondary controller 110-1, it is contemplated that in some examples the control systems of the present specification may have two or more secondary controllers, each secondary controller associated with a corresponding MMG in the grid. One such example control system having two or more secondary controllers is shown in FIG. 2 and described in relation thereto.

Grid 120 also comprises an electrical utility 155-1 connected to transmission line 145. Electrical utility 155-1 may also be described as utility 155-1, in short. A utility circuit breaker (UCB) 160-1 is interposed between utility 155-1 and transmission line 145. In some examples, grid 120 may also comprise one or more additional utilities connected to transmission line 145 via a corresponding UCB interposed between the corresponding utility and transmission line 145. An example of such additional utility is a utility 155-m connected to transmission line 145 via a corresponding UCB 160-m interposed between utility 155-m and transmission line 145. m can be a natural number greater than one. In FIG. 1, utility 155-m and UCB 160-m are shown in dashed lines to indicate that grid 120 need not comprise utility 155-m and UCB 160-m, and may comprise one utility 155-1 and its corresponding UCB 160-1. It is also contemplated that in some examples grid 120 may comprise two or more utilities and their corresponding UCBs. The utilities and UCBs may be generically or collectively referred to as utilities 155 and UCB 160, respectively.

System 100 also comprises tertiary controller 115, which is to be in communication with secondary controller 110-1, utilities 155 and UCBs 160. As shown in FIG. 1, system 100 comprises primary, secondary, and tertiary controllers organized in a hierarchical or multi-level manner. Dividing the control system complexity among multiple levels of controllers reduces the computational or processing load in each controller, thereby reducing computational delays and improving response time. Moreover, having multiple levels of controllers allows each controller to be placed at a relatively shorter electrical distance to the grid subparts or components being controlled by that controller. This shortened electrical distance reduces delays of communications and commands between each controller and its corresponding grid subparts or components. In addition, dividing the control functionality among multiple levels of controllers increases the resilience of the control system, as the control system may remain at least partially functional if one or a few of the individual controllers become non-functional due to an issue such as malfunction, natural disaster, cyberattack, or the like.

Turning now to FIG. 2, a schematic representation is shown of another example control system 200 for controlling two or more MMGs. System 200 is similar to system 100, with a difference being that system 200 comprises two or more additional primary controllers 205-1 to 205-q, and one or more additional secondary controllers 110-p, where p and q are natural numbers greater than one. System 200 may be used to control a grid 220. Grid 220 is similar to grid 120, with a difference being that grid 220 comprises one or more additional MMGs 140-p, each connected to transmission line 145 via a corresponding MMGCB 150-p. In FIG. 2 the three black circles between MMG 140-1 and MMG 140-p are intended to signify that grid 220 may comprise two, three, or a larger number of MMGs.

Secondary controller 110-p is associated with MMG 140-p, and is to be in communication with primary controllers 205-1 to 205-q. Secondary controller 110-p is also to be in communication with MMGCB 150-p interposed between MMG 140-p and transmission line 145. Tertiary controller 115 is also to be in communication with secondary controller 110-p. MMG 140-p comprises two or more MGs 225-1 to 225-q, each such MG connected to feeder line 233 of MMG 140-p. MGs 225-1 to 225-q may be referred to generically to collectively as MGs 225. Each of MGs 225 is connected to feeder line 233 at a PCC 235. Similar to PCC 135, PCC 235 need not be a single physical point on feeder line 233. PCC 235 may be considered as a point of functional delineation between the MG and the MMG. In other words, PCC 235 may be considered as a point in the grid where, operationally, each MG 225 presents its operational parameters (e.g. voltage, frequency, etc.) to the rest of MMG 140-p. While in FIG. 2 PCC 235 is depicted as being at a certain position on feeder line 233, it is contemplated that the PCC could also be another point or region along feeder line 233. For each of MGs 225-1 to 225-q, a corresponding MGCB 230-1 to 230-q is interposed between the MG and feeder line 233.

While FIG. 2 shows a dashed line between controller 110-1 and PCC 135 and between controller 110-p and PCC 235, indicating that each such controller may receive information or measurements regarding operational parameters at the corresponding PCC, it is contemplated that in some examples one or more of controllers 110-1 to 110-p need not be in direct communication with their corresponding PCC. In some such examples, one or more of controllers 110-1 to 110-p may receive the measurements of the operational parameters at their corresponding PCC indirectly, i.e. from another component. Moreover, in some other such examples, one or more of controllers 110-1 to 110-p need not receive measurements of operational parameters at their corresponding PCC.

In some examples, one or more of the MGs may each comprise one or more of a source to generate electrical energy, a load to consume electrical energy, and a battery energy storage system (BESS) to store or release electrical energy. Moreover, in some examples, the MG may comprise a load, and one or more of a source and a BESS. FIG. 3 shows a schematic representation of an example MG 305. MG 305 may be similar to one or more of MGs 125 or MGs 225. MG 305 comprises a first component 310, which may comprise one of a source, a load, or a BESS. MG 305 may also comprise one or more additional components 315 and 320, each of which additional components may comprise one of a source, a load, or a BESS. In some examples, component 310 may comprise a load, and components 315 and 320 may each comprise one or more of a source and a BESS.

Moreover, in some examples, MG 305 may comprise one source, one load, and one BESS. In FIG. 3 component 320 is shown in dashed lines to indicate that in some examples MG 305 need not comprise component 320. It is also contemplated that in some examples MG 305 may comprise two, four, or another number of components. In some examples, the components of MG 305 may be electrically connected with one another.

In systems 100 and 200 shown in FIGS. 1 and 2, the MGs are controlled by corresponding primary controllers. It is also contemplated that in some examples, one or more of the components internal to the MG may have their own local controllers. For example, a BESS may have its own local controller to control the BESS. In examples where the internal components of a MG have their own internal controllers, the primary controller for that MG may be configured to be in communication with one or more of those internal controllers, to control or coordinate the operation of the various components of the MG. FIG. 3 shows internal controllers 325, 330, and 335 corresponding to MG components 310, 315, and 320 respectively. In FIG. 3 internal controllers 325, 330, and 335 are shown in dashed lines to indicate that in some examples one or more of components 310, 315, and 320 need not comprise one or more of internal controllers 325, 330, and 335 respectively.

In some examples, one or more of the primary controllers, the secondary controller, and the tertiary controller may comprise processing hardware configured to execute machine-readable instructions. Moreover, in some examples this processing hardware may comprise a programmable logic controller (PLC). Furthermore, in some examples, this processing hardware may comprise a central processing unit (CPU), a graphics processing unity (GPU), or other type of micro-processor.

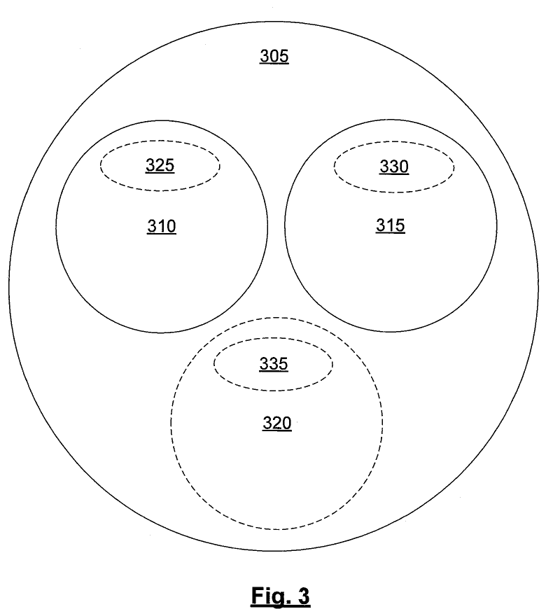

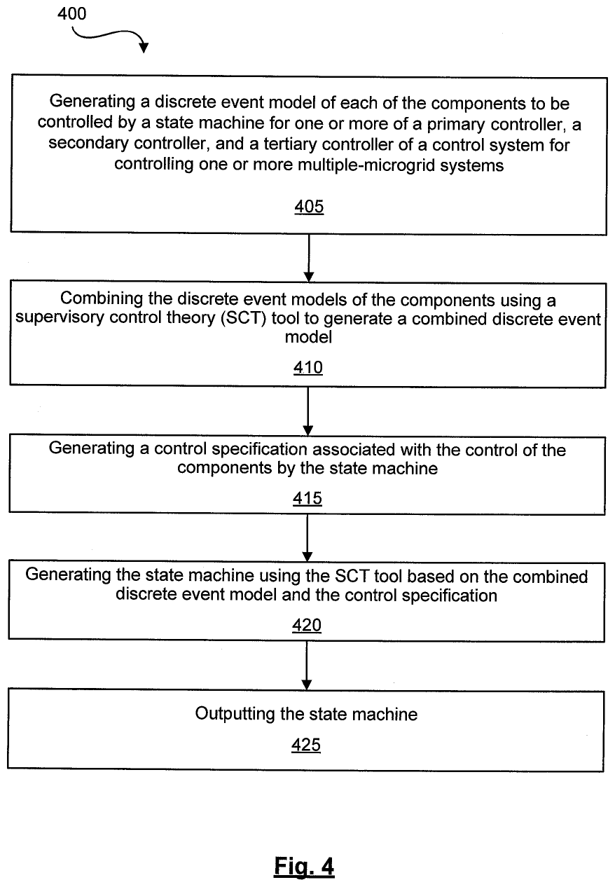

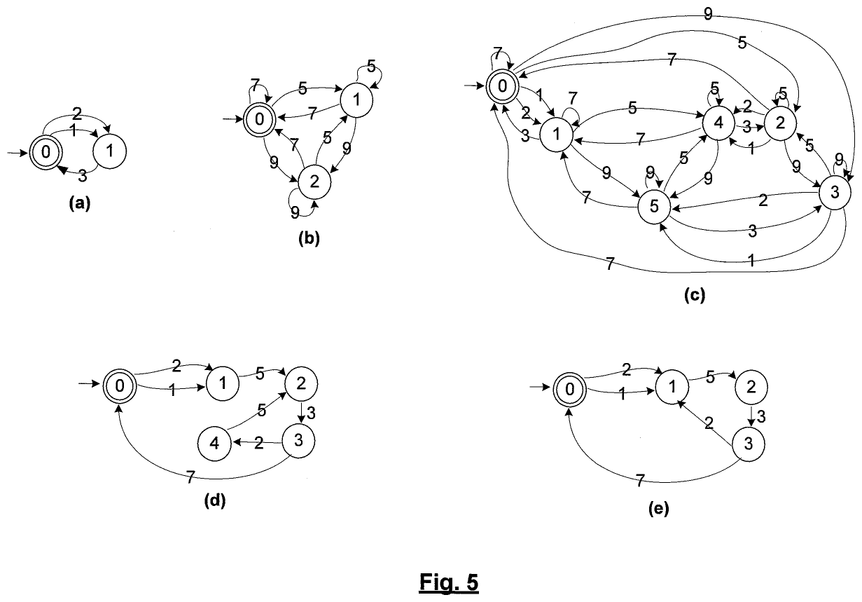

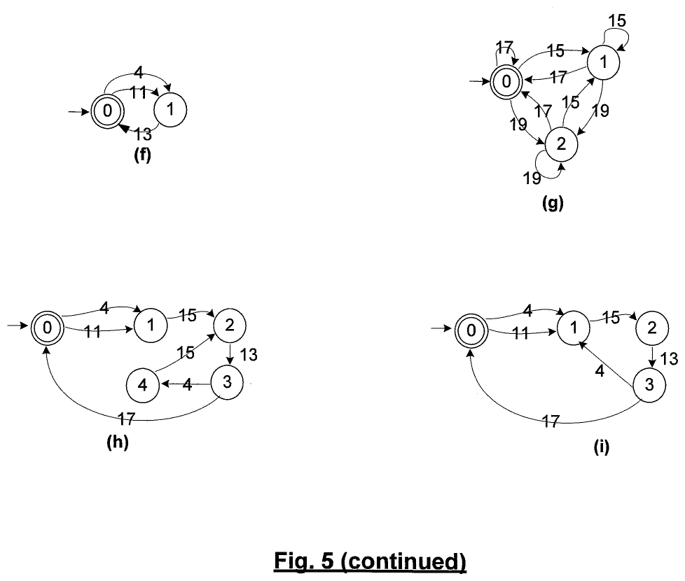

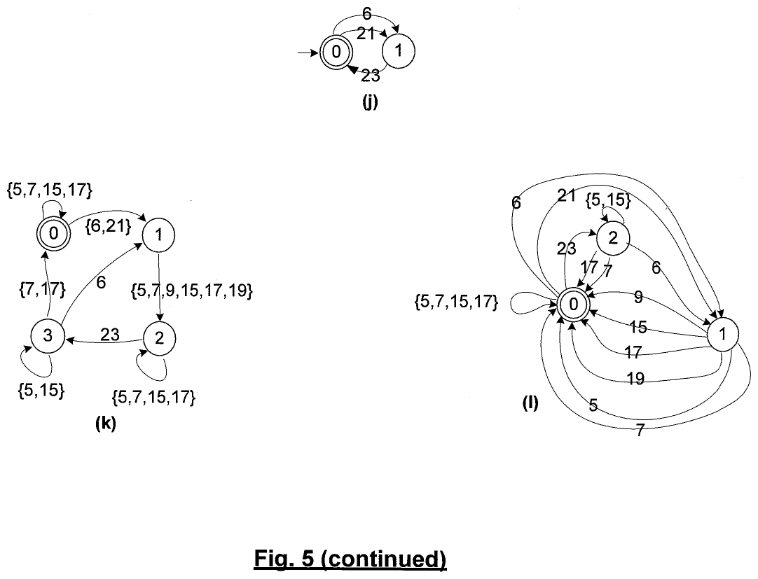

In addition, in some examples, the machine-readable instructions may embody a state machine. Such a state machine may include representations of the various states of a given grid component or subpart, and possible transitions between those states. Examples of such state machines are shown in FIGS. 5(e), (i), and (I), and described further in relation thereto. It is also contemplated that in some examples the machine-readable instructions may include other representations such as look-up tables, databases, decision trees, trained machine learning models, and the like.

Moreover, in some examples, the various states of a given grid component or subpart may be discretized to facilitate representing those states using a state machine. As such, the state machine may be based on a discrete event model of one or more of: the one or more MGs, the one or more MGCBs, the one or more MMGs, the one or more MMGCBs, the one or more electrical utilities, and the one or more UCBs. Some grid components such as circuit breakers have inherently discrete states or events: a circuit breaker can be open (disconnected) or closed (connected), and can transition between those two discrete states.

For the other grid components which may have a broader or continuous range of states or operating conditions, the continuous range of states may be divided into discrete states. For example, a BESS may have states of charge (SOC) that can vary continuously from 0% to 100%. To discretize these states, the full continuous range can be divided into a first state with SOC of 0% to 30% representing low SOC, a second state with SOC of greater than 30% to 80% representing optimal SOC, and a third state with SOC of greater 80% to 100% representing high SOC. In this manner, a discrete event model of the BESS may be generated, which model has three discrete states and may allow for transitions between those states. These percentages are for illustrative purposes, and it is contemplated that in some examples the states of a BESS may be discretized into a number of discrete states with SOC cut-offs other than those described above.

A similar approach may be used to generate a discrete event model of other components of a gird. To generate a discrete event model of a multi-component subpart of the grid, for example a MG that has multiple components, the discrete event models of the various components of that grid subpart may be combined to form a combined discrete event model. This combined discrete event model may itself be represented as a state machine. In some examples, a synchronous product of the various discrete event models may be used to generate the combined discrete event model. Moreover, in some examples, a tool powered by the Supervisory Control Theory (SCT) may be used to combine the various state machines into the combined discrete event model. SCT is described in greater detail in Wonham, W. Murray, and Kai Cai. “Supervisory control of discrete-event systems.” (2019): 2005-06, which is incorporated herein by reference in its entirety. Furthermore, in some examples this SCT tool may be implemented using a software called TCT™ associated with the W. Murray Wonham research group at the University of Toronto, and made available by them via their research group website at https://www.control.utoronto.ca/˜wonham/Research.html. Generation of the combined discrete event model is described further in relation to FIG. 5(c). In addition, examples of generation of the combined discrete event model are also described in U.S. Provisional Patent Application No. 63/427,987, filed on Nov. 25, 2022, which is incorporated herein by reference in its entirety.

In addition, there may be operational targets or goals for the grid or grid subparts. Examples of such operation targets may include: keeping the BESS SOC within an optimal range, keeping the operational parameters (e.g. voltage, frequency, current, etc.) at the PCC within an optimal range, and the like. These operational targets may be summarized or reflected in a control specification. The control specification may set out how one or more grid subparts or components should behave in different scenarios or under various dynamic conditions to achieve the operational targets. In some examples, the control specification may also be in the form of a state machine.

In some examples, in order to enable hierarchical control systems such as those described herein, the control specification may also be specified at different levels of a hierarchy. For example, the overall control specification may be divided into a control specification associated with a primary controller, a control specification associated with a secondary controller, and a control specification associated with a tertiary controller.

The state machines that power the primary, secondary, and tertiary controllers of control systems described herein may then be generated based on the combined discrete event model and the control specifications. In some examples, the generation may include using a SCT tool to generate the state machine based on the combined discrete even model and the control specification. Generation of the state machine is described further in relation to FIGS. 5(a) to (l). In addition, examples of generation of the state machine are also described in U.S. Provisional Patent Application No. 63/427,987, filed on Nov. 25, 2022, which is incorporated herein by reference in its entirety.

Because the combined discrete event model can capture all possible discretized states and transitions between states of the associated gird subpart or grid, and the associated state machines powering the primary, secondary, and tertiary controllers are generated based on these combined discrete event models, the control systems described herein (comprising the primary, secondary, and tertiary controllers and their associated state machines) can systematically envision and cover all possible discretized states of the associated grid subpart or grid they are to control. For example, a state machine associated with a primary controller for a corresponding MG may cover all possible events in the discrete event model of that MG.

As such, the example control systems described herein that are powered by state machines need not have the same limitations of control systems that use manual enumeration of dynamic conditions and manually list responses. In addition, the state machines of the example control systems described herein already include a response behavior for each possible discrete state of the grid subpart or grid they control. As such, the example control systems described herein that are powered by state machines are not subject to prediction errors and uncertainty, and need not be subject to delays due to computational load of having to generate a response in real time when a dynamic condition affecting a grid component or subpart occurs.

In some examples, the control systems described herein implement certain control strategies or behaviors. These strategies or behaviors may be reflected in the control specifications, and ultimately in the state machines that power the primary, secondary, and tertiary controllers of the control systems. For example, when a given MGCB is open, the corresponding MG may be disconnected or islanded from the rest of the MMG and grid. In such a scenario, the primary controller associated with the given MGCB may control the islanded MG associated with the given MGCB by controlling one or more of the source, the load, and the BESS associated with the islanded MG. The secondary controller and the tertiary controller may not participate in controlling the islanded MG, since the islanded MG is disconnected from its corresponding MMG and the rest of the grid. In some such examples, the primary controller associated with the islanded MG may control the energy storage component (e.g. BESS, and the like) in the MG to stabilize operational parameters such as voltage and frequency in the MG. The primary controller may also check operational limits of the BESS and re-adjust internal operation of the MG, including output of other energy sources and intake of the loads, to keep the BESS within its permitted or optimal operational limits.

Moreover, in some examples, when two or more given MGCBs are closed and the associated given MMGCB is open, the secondary controller associated with the given MMGCB may control the given primary controllers associated with the two or more given MGCBs to coordinate the operation of the given primary controllers. The secondary controller may also receive measurements of operational parameters measured at its corresponding PCC. In such a case the MMG is islanded from the rest of the grid, but two or more MGs inside the MMG are connected to the MMG. The primary controllers of the connected MGs may control the internal functioning of their corresponding MGs. Since the MGs are connected to the feeder line at the PCC, the secondary controller may receive measurements of the operational parameters at the PCC, and use these measurements to send commands to coordinate the operation of the primary controllers of the connected MGs.

In some examples, coordinating the primary controllers may include controlling the primary controllers to in turn control their MGs to cooperate to maintain the operational parameters at the PCC within their optimal or permitted range. Furthermore, in some such examples, the secondary controllers may control the primary controllers associated with the connected MGs to control the energy storage component (e.g. BESS, and the like) in the MG to stabilize operational parameters such as voltage and frequency at the PCC. The secondary controller may also control the primary controllers to check operational limits of their corresponding BESS and re-adjust internal operation of the MG, including output of other energy sources and intake of the loads, to keep the BESS within its permitted or optimal operational limits. Moreover, in some examples, the secondary controller may coordinate the primary controllers to ensure their operations do not conflict with one another. In addition, in some such examples, the tertiary controller may not participate in controlling the islanded MMG.

Furthermore, in some examples, two or more given MGCBs may be closed, the associated given MMGCB may be closed, and the UCBs may be open. In such an example, two or more MGs are connected to their corresponding MMG, which MMG is connected to the transmission line of the grid. The utilities, however, are disconnected from the grid. In such examples, the secondary controller associated with the connected MMG may control the primary controllers associated with the connected MGs. The secondary controller may also receive measurements of operational parameters measured at the PCC. The functionality of the primary and secondary controllers in such an example may be similar to those described above in relation to other examples where two or more MGs are connected to the feeder line of the MMG.

Moreover, in some such examples, the tertiary controller may dictate one or more of the operational parameters at the PCC. Dictating these parameters may include setting the optimal or permitted values or ranges for these parameters, and communicating that information to the secondary controllers. The PCC is functionally also the point where the feeder line of the connected MMG connects to the transmission line of the grid. By dictating the operational parameters at the PCC, the tertiary controller may control or coordinate the one or more connected MMGs to maintain the operational parameters at the PCC and in the transmission line.

Furthermore, in some such examples, the secondary controller of the connected MMG may collect from the primary controllers of the corresponding MGs information about the operational condition of the storage components (e.g. BESS, and the like) inside each connected MG. Then the secondary controller may identify storage systems that can collectively stabilize operational parameters of the connected MMG (e.g. as measured at the PCC), and the secondary controller may then control the corresponding primary controllers to in turn control the storage systems in each connected MG to stabilize and maintain the operational parameters. In some examples, the target operational parameters may be those dictated by the tertiary controller. In addition, in some examples such operational parameters may include one or more of voltage, phase, current, and the like. The primary controllers may also control the sources and loads in each corresponding MG to assist the storage components in those MGs to remain within their optimal or permitted range of operational parameter, such as SOC and the like.

In addition, in some examples, two or more given MGCBs may be closed, the associated given MMGCB may be closed, and one or more of the UCBs may also be closed. In such an example, two or more MGs are connected to their corresponding MMG, which MMG is connected to the transmission line of the grid. One or more utilities are also connected to the grid. In such examples, the tertiary controller may receive utility operating parameters from one or more of the utilities associated with the closed UCBs, i.e. from the utilities connected to the grid. In some examples, these utility operating parameters may include one or more of: import-export of power, need for voltage support, and the like. The tertiary controller, in turn, may communicate these utility operating parameters to the secondary controller of the connected MMG. The tertiary controller may also dictate one or more of the operational parameters at the PCC.

In some such examples, the secondary controller associated with the connected MMG may control the primary controllers associated with the two or more given closed MGCBs, i.e. the primary controllers of the connected MGs. For example, the secondary controller may collect information about the storage system or component inside each connected MG from the corresponding primary controllers. In addition, the secondary controller may identify storage systems or components that can respond to the operational parameters dictated by the tertiary controller, and may also share that identification and those operational parameters with the primary controllers of the connected MGs. Moreover, the primary controllers may control the sources and loads in each corresponding MG to assist the storage components in those MGs to remain within their optimal or permitted range of operational parameter, such as SOC and the like. Furthermore, the secondary controller may receive measurements of operational parameters measured at the PCC.

Moreover, in some examples more than one MMG may be connected to the grid and the control system may also comprise more than one corresponding secondary controller, each corresponding to one of the MMGs. Examples of such a grid and control system are shown in FIG. 2, and described in relation thereto. In some such examples, two or more given MGCBs may be closed, the associated given MMGCB may be closed, the further MMGCB may be closed, and the one or more UCBs may be open. In other words, two or more MMGs are connected to the grid and the utilities are disconnected from the grid. One or more of the connected MMGs may each have two or more connected MGs. The secondary controllers of the first and second connected MMGs may be referred to as the secondary controller and the further secondary controller respectively. It is also contemplated that in some examples the grid may comprise more than two connected MMGs, and the corresponding control system may comprise more than two secondary controllers.

In some such examples, the secondary controller associated with the given MMGCB (i.e. the first connected MMG), may control the given primary controllers associated with the two or more given MGCBs. In other words, the secondary controller may control the primary controllers of the associated connected MGs. As described above, examples of such control may include determining whether a storage system can help in maintaining operational parameters, controlling sources and loads in an MG to maintain the storage system within its optimal or permitted range of operational parameters, and the like. The secondary controller may also receive measurements of the operational parameters measured at the PCC.

Moreover, in such examples, the further secondary controller may control the given further primary controllers associated with the further corresponding MMG and receive measurements of the operational parameters measured at the PCC. In other words, the further secondary controller may perform functions similar to those of the secondary controller, with a difference being that the further secondary controller performs those functions in relation to its corresponding further MMG.

Furthermore, in such examples, the tertiary controller may control the secondary controller and the further secondary controller to coordinate the operation of the secondary controller and the further secondary controller. For example, the tertiary controller may control and coordinate the secondary controllers to maintain the operational parameters at the PCC or the transmission line. The tertiary controller may also coordinate the secondary controllers to prevent them from behaving in ways that are conflicting or contradictory with one another. The tertiary controller may also dictate one or more of the operational parameters at the PCC.

In addition, in some examples, two or more given MGCBs may be closed, the associated given MMGCB may be closed, the further MMGCB may be closed, and one or more of the UCBs may also be closed. In other words, two or more MMGs are connected to the grid and one or more utilities are also connected to the grid. In such examples, the tertiary controller may receive utility operating parameters from one or more of the utilities associated with the closed UCBs, i.e. from the one or more utilities connected to the grid. The tertiary controller may also communicate the utility operating parameters to the secondary controller and the further secondary controller, and control the secondary controller and the further secondary controller. Examples of controlling the secondary controller and the further secondary controller may be similar to those described above. The tertiary controller may also dictate one or more of the operational parameters at the PCC.

In some such examples, the secondary controller associated with the given MMGCB may control the given primary controllers associated with the two or more given MGCBs, and receive measurements of operational parameters measured at the PCC. The further secondary controller may control the given further primary controllers associated with the further corresponding MMG, and also receive measurements of the operational parameters measured at the PCC. It should be noted that while FIG. 2 shows two PCCs, each corresponding to a MMG, when the MMGs are connected together via the transmission line, the two PCCs may functionally be the same point. In other words, the operational parameters may be substantially the same or similar along the transmission line and along the feeder lines of each of the MMGs connected to the transmission line.

The above examples provide some example control strategies presented as the behavior of the primary, secondary, and tertiary controllers under different conditions of the various CBs being open or closed at the MG, MMG, and utility levels. These control strategies may be reflected in the control specifications, which may in turn be used to generate state machines for the primary, secondary, and tertiary controllers of the control systems described herein.

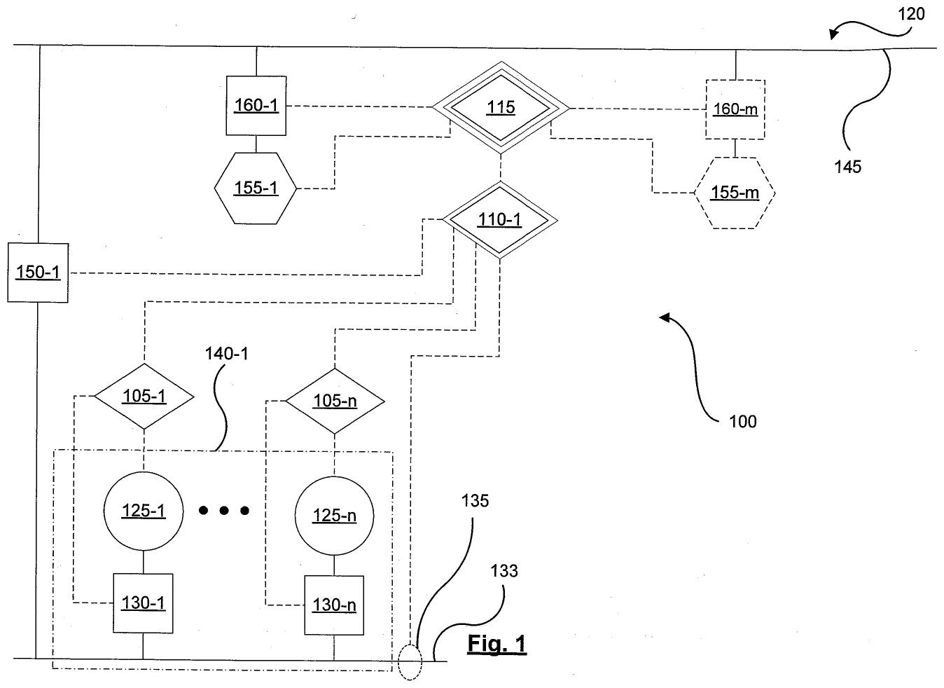

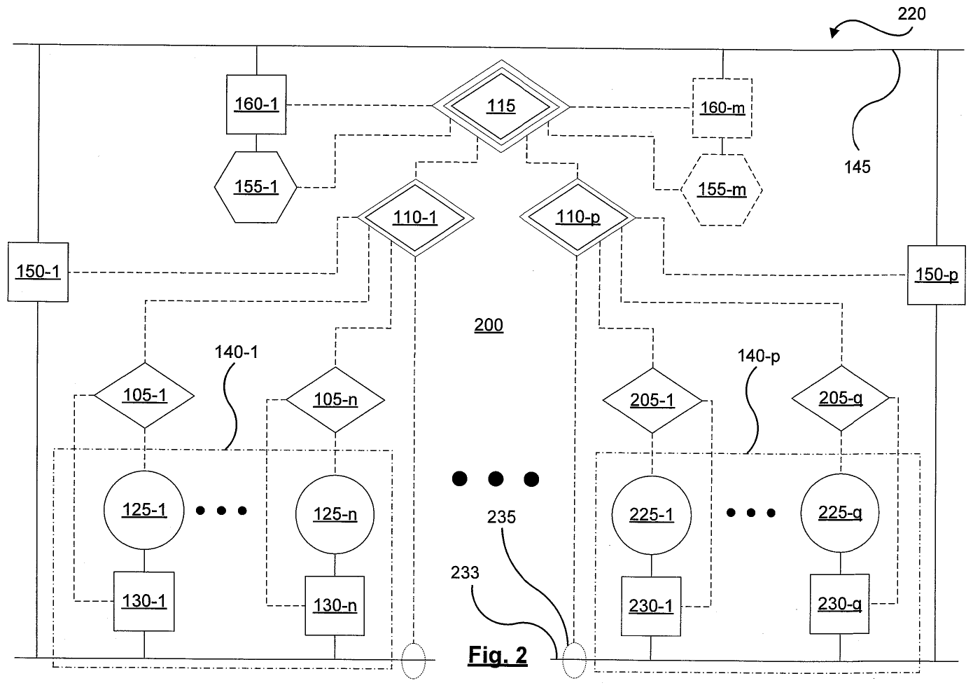

Turning now to FIG. 4, a flowchart is shown of an example method 400 for generating the state machine for one or more of the primary controller, the secondary controller, and the tertiary controller of the control systems described herein. At box 405, a discrete event model may be generated of each of the components to be controlled by the state machine. In some examples, such a discrete event model may include various discrete states of a component, and the transitions between those states. Moreover, in some examples, such state machines may be similar to those shown in FIGS. 5(a), (b), (f), (g), and (j), and described in relation thereto.

At box 410, the discrete event models of the components may be combined using a supervisory control theory (SCT) tool to generate a combined discrete event model. Examples of such a SCT tool may include the TCT software, and the like. Moreover, an example of such a combined discrete event model is show in FIG. 5(c), and described in relation thereto.

At box 415, a control specification may be generated, the control specification being associated with the control of the components by the state machine. In some examples, such a control system may be generated based on the nature of the components and the behavior to be expected from, or dictated to those components. Such behavior may be based on the overall operational targets or control strategy for the grid subpart or grid within which the components operate. Examples of control specifications are shown in FIGS. 5(d), (h), and (k), and described in relation thereto. Furthermore, in some examples, different control specifications may be generated corresponding to operational objectives or control strategies at different levels of hierarchy. These different control specifications directed to a hierarchical approach to controlling a grid may then be used to generate state machines for primary, secondary, and tertiary controllers as part of a control system implementing a hierarchical approach to controlling a grid or grid subpart.

Turning now to box 420, the state machine may be generated using the SCT tool. The state machine may be generated based on the combined discrete event model and the control specification. Examples of such a state machine are shown in FIGS. 5(e), (i), and (l), and are described in relation thereto.

At box 425, the state machine may be output. In some examples, outputting the state machine may comprise saving or transferring the state machine to processing hardware configured to execute machine-readable instructions. Such processing hardware may be similar to the example processing hardware described herein. In some examples, such processing hardware may comprise a PLC. Such a PLC may then be electrically connected to the grid subpart or grid, to control that grid subpart or grid by executing the machine readable instructions embodied by, or in the form of, the state machine. It is also contemplated that in some examples, outputting the state machine may include saving the state machine to a machine readable storage medium, sending the state machine in the form of digital data to another component or system, sending the state machine to another system for testing or validation, and the like.

In some examples, method 400 may further comprise, before generating the state machine, determining, using a synchronous product function of the SCT tool, whether the combined discrete event model is non-blocking. Examples of being non-blocking are described in greater detail in relation to FIGS. 5(a) to (l). If this determination is negative, i.e. if the combined discrete event model is determined to be blocking, then a revised discrete event model of one or more of the components may be generated. The combined discrete event model may then be regenerated using the SCT tool based on the revised discrete event model. In this manner, revising the discrete event model may be used to generate a non-blocking combined discrete event model. In some examples, discrete event model of one or multiple components may not include a sequence of discrete-state transitions back to the initial (marker) discrete state which can result in synchronous product of discrete event model of multiple components to become blocking. For example, a MGCB opening, as a discrete event, requires the MGCB closing, as another discrete-event, to bring MGCB back to initial closed state. If the MGCB closing is not envisioned as a discrete event, the MGCB discrete-event model would exhibit a blocking behavior. A corresponding revision to discrete event model to address the cause of the blocking behavior may alleviate or address the blocking behavior.

Furthermore, in some examples, method 400 may further comprise, before outputting the state machine, determining whether the state machine is empty. This would represent a situation where a state machine could not be generated by the SCT tool based on the combined discrete event model and the control specification. If the determination is affirmative, then a revised discrete event model of the one or more components may be generated. A revised combined discrete event model may also be generated using the SCT tool based on the revised discrete event model. The state machine may also be regenerated using the SCT tool based on the revised combined discrete event model and the control specification. Regenerating the state machine based on the revised combined discrete event model may assist in obtaining a non-empty state machine. For example, a discrete event model of one or multiple components may not be controllable in nature, i.e., an uncontrollable event (such as opening of a MGCB in an accidental manner) may occur in the discrete event model of multiple components which may not be captured in the control specification. Hence, there may be no state machine available to enforce the control specification on discrete event behavior of multiple components. This, in turn, may lead to an empty state machine. A corresponding revision to the discrete event model of the one or more components may be used to address or alleviate the empty state machine. In some examples, controllability may be systematically defined as follows:

Assuming V is a controller and G is discrete event model of multiple components generated by synchronous product of SCT. For V to provide controllable supervision (with respect to G):

(∀s,∀σ)s∈(discrete states of G) & σ∈(discrete events of G) & sσ∈(control specification) then (∀sσ)⊆V is a controllable state machine

Moreover, in some examples, method 400 may further comprise, before outputting the state machine, determining, using a synchronous product function of the SCT tool, whether the state machine is non-blocking. If the determination is negative, a revised control specification may be generated. Then the state machine may be regenerated using the SCT tool based on the combined discrete event model and the revised control specification. In this scenario, revising the control specification may be used to facilitate obtaining a non-blocking state machine. For example, a state machine may be generated using the SCT tool which means that the synchronous product of one or multiple components is controllable. However, the defined control specification may not be able to control the system back to initial (marker) state. For example, the MGCB may be open in an accidental manner which may also be captured in the control specification. A BESS in the MG may be utilized to bring MG back to the initial state. However, if the BESS control action is not captured in the control specification, the generated state machine is blocking, i.e., not being able to transit back to the initial state. A corresponding revision to the control specification to address the cause of the blocking behavior may alleviate or address the blocking behavior.

In addition, in some examples, another state machine may be generated using method 400. This other state machine may be generated based on another combined discrete event model and another control specification. Then, using the synchronous product function of the SCT tool, a determination may be made as to whether the state machine is non-conflicting with the other state machine. Examples of being non-conflicting are described in greater detail in relation to FIGS. 5(a) to (l). If this determination is negative, then one or more of the following steps may be taken: generating a revised control specification and generating a revised other control specification. An example of this type of situation my arise when generating state machines for primary controllers associated with a first and second MG within a MMG. If the two state machines for the two primary controllers are determined to be conflicting with one another, then one or more of the first control specification and the second control specification may be revised. The state machines may then be regenerated based on the one or more revised state machines, to assist with obtaining non-conflicting state machines. For example, a discrete event may be required to be enabled in one state machine to bring a combination of multiple components back to an initial state; while, the same discrete event exists in the other state machine; however, the other state machine is not at a discrete state to be able to enable the common discrete event. Therefore, the state machine and the other state machine may become conflicting. For example, a generated state machine may command a BESS to start charging owing to low SOC level; while, another state machine at the same time may command the BESS to discharge owing to high amount of power output from the BESS. Such scenario is a conflicting scenario between the two state machines where prioritizing one state machine, e.g., the one controlling power flow, over the other state machine, i.e., the one controlling SOC, may resolve such confliction. A corresponding revision to the one or both of the control specifications to address the cause of the conflicting behavior may alleviate or address the conflicting behavior.

Referring now to FIG. 5(a), a schematic representation is shown of an example discrete event model of a MGCB. This discrete event model comprises circles representing states and arrows representing transitions between those states. Such transitions may also be referred to as “discrete events” or “events” in short. Discrete event number 2 represents opening of the MGCB in an accidental manner, e.g. due to grid faults, in a grid or power system. Discrete event number 1 represents opening of the MGCB in an intentional manner. The two mentioned discrete events exit the MGCB initial state 0 indicated by a double circle. The initial state may represent a desired or marker state of the discrete event model which corresponds to the MGCB being in the closed state. Both discrete events 1 and 2 enter state 1, which corresponds to MGCB being in an open state. Discrete event number 3 represents closing of the MGCB which is intentional in nature. The discrete event number 3 transits from state 1, i.e., MGCB being open, back to initial state 0 which relates to MGCB being closed. For the discrete event model shown in FIG. 5(a) as well as the rest of the discrete event models described herein, in order for the discrete event model to remain non-blocking, there should be at least one set of transitions or discrete events leading back to the initial or marker state. Otherwise, the discrete event model is referred to as a blocking model.

As mentioned above, within one discrete event model, discrete events are visualized by arrows and discrete states are visualized by circles. Within a given discrete event model, the same numeral may be used to indicate both a state and a transition; for example, FIG. 5(a) includes a state 1 and a transition or event 1. Although the same number may be used for a state and a transition, the two are distinct. The same condition is applied to the rest of the discrete event models in the drawings, and described herein.

FIG. 5(b) shows a schematic representation of an example discrete event model of an example BESS located in a MG. Three distinct operation states are envisioned in discrete modeling of the BESS. State 0 represents operation of the BESS when the MG is connected to one or multiple utilities, i.e., MGCB, MMGCB, and UCB(s) are closed. In such a discrete state, the BESS operates in so called grid-following condition where the BESS follows the operation conditions dictated by the utility (utilities). State 1 represents operation of the BESS when the MG is neither connected to one or multiple utilities nor to the other MG, i.e. MGCB is open. In such a discrete state, the BESS is forming voltage and frequency of the corresponding MG to which the BESS is connected. State 2 represents operation of the BESS when the MG is not connected to one or multiple utilities but is connected to the other MG and may be connected to another MMG, i.e. MGCB and/or MMGCB are/is closed and UCB(s) is (are) open. In such a discrete state, the BESS, in coordination with the other one or multiple BESS, located in the other one or multiple MG systems, is forming voltage and frequency of the corresponding one or multiple MMG systems.

As long as the BESS remains in state 0, the BESS remains in grid following mode, which is represented by a self loop of discrete event 7. Discrete event 5 implies transition of the BESS from grid following mode to a grid forming mode for a single MG system. Hence, as soon as discrete event 5 is enabled a transition takes place either from discrete state 0 to discrete state 1 or from discrete state 2 to discrete state 1. In addition, as long as the BESS remains in state 1, the self loop of discrete state 5 remains active to represent operation of the BESS in grid forming condition in the context of a single-MG system. When the discrete event 9 is enabled, it implies transition of the BESS from grid forming mode for a single MG system, to grid forming mode in the context of a multiple-MG system or MMG. As long as the BESS remains in discrete state 2, operation of the BESS in grid forming mode for multiple-MG systems remains active via a self-loop of discrete event 9.

Referring to FIGS. 5(a) and (b), while the discrete event models in both of these figures include states designated as 0 and 1, the states 0 and 1 in FIG. 5(a) need not be, and may not be, the same as states 0 and 1 in FIG. 5(b). In general, states designated with the same numeral in different FIGS. 5(a) to (l) need not be, and may not be, the same as one another. In other words, the states in each given state machine shown in FIGS. 5(a) to (l) may be specific to that given state machine, regardless of whether the same numeral is used to designate other states in other state machines in FIGS. 5(a) to (l). One reason is that a discrete state represents internal behavior of a grid component and by nature it generally is not possible to transfer internal behavior of one component to the internal operation of the other components of the grid.

While states with the same number in different state machines may be different states (because they are states of different components), the transitions or events with the same number in different states machines represent the same transition. One reason is that when multiple MG components are combined discrete events of the multiple MG components will be represented in one discrete event model.

In FIG. 5(b) the discrete event model of the BESS is constructed based on the grid forming and grid following conditions. In an example discrete event model of the BESS described earlier above, a discrete event model of the BESS was proposed based on the SOC of the BESS. A discrete event model of a given component may be defined or constructed based on different behaviors or parameters of a given component, based on the ultimate control objectives or control strategies of a given control system.

FIG. 5(c) shows a schematic representation of an example combined discrete event model generated by combining the discrete event models of FIG. 5(a) and FIG. 5(b). In some examples, such a combined discrete event model may be generated using a SCT tool, such as the SCT tools described above. Moreover, in some examples, the SCT tool may comprise or implement a synchronous product of the discrete event models of FIGS. 5(a) and 5 (b). Developing the combined discrete event model of Fig. (c), including all its discrete states and discrete events, is not trivial, and my be impracticable or impossible, using manual or ad-hoc approaches. Such a comprehensive representation of the grid subpart behavior may be used to generate the state machine for one or more of the primary, the secondary, and the tertiary controllers.

The discrete event model of FIG. 5(c) represents all possible sequences in transitions of discrete events from collective operation of the discrete event models of FIG. 5(a) and FIG. 5(b). As described above, a transition with a given number in FIG. 5(c) is the same as, or functionally equivalent to, a transition of the same number in FIG. 5(a) or 5(b). The discrete states provided in FIG. 5(c) are as a result of the collective operation of MGCB and BESS. Discrete state 0 represents MGCB being in closed state and BESS operating in grid-following mode. State 1 represents MGCB being open and BESS still operating in grid-following mode. Discrete state 2 shows MGCB being closed and BESS operating in grid formation for a single-MG system. Discrete state 3 represents MGCB remaining closed and BESS operating in grid formation mode for multiple-MG system. Discrete state 4 shows MGCB becomes open and BESS operating in grid-forming mode for single-MG system. Discrete state 5 shows MGCB being open and BESS operating in grid formation for multiple-MG system.

The synchronous product may be denoted by “∥” and may generate all possible sequences in occurrence of discrete events and resulting discrete states from collective operation of grid components or subparts.

$$Fig . 5 ( c ) = Fig . 5 ( a ) ‖ Fig . 5 ( b )$$

It should be noted that the discrete event model of FIG. 5(c) represents all possible discrete-event scenarios that can take place as a result of collective operation of FIGS. 5(a) and (b). However, only a subset of all discrete states may be permitted for operation of multiple-microgrid system and the behavior may be restricted based on a proper control specification. For example, discrete state 2 in FIG. 5(c) represents MGCB remaining closed while BESS operating in grid forming condition and not grid following condition although the multiple-microgrid system is not disconnected from the grid. Hence, state 2 is a contradiction in operation of MGCB and BESS and should be avoided using a proper control specification, as described in greater detail below.

FIG. 5(d) shows a schematic representation of an example control specification for the operation of the BESS in the MG based on the status of the MGCB of that MG. The control specification is generally a subset of the synchronous product of various discrete event models of the associated grid components. In this example, the control specification of FIG. 5(d) is a subset of the discrete event model of FIG. 5(c). In this example, the control specification is designed to enforce desired operational requirements in the collective operation of MGCB discrete event model of FIG. 5(a) and BESS discrete event model of FIG. 5(b). The discrete events (transitions) are of the same events with the same number of those previously defined. Discrete state 0 is when the MGCB is closed and the BESS operates in grid following mode. Discrete state 1 is when MGCB is open either accidentally (after discrete event 2) or intentionally (after discrete event 1). Discrete state 2 is when the BESS operates in grid forming condition, which is expected since the MGCB is already open. Discrete state 3 represent status of MGCB being closed. Discrete state 4 indicates possibility of MGCB becoming open accidentally before discrete event 7 is enabled and putting BESS back in grid forming condition.

The possibility of dictating or enforcing the devised control specification of Fig. (d) over the entire grid subpart of FIG. 5(c) may be comprehensively conducted by the SCT tool by ensuring that there is no single discrete event that may occur in the entire grid subpart of FIG. 5(c) which may contradict with the behavior defined in the control specification of FIG. 5(d). In other words, the SCT tool checks if the control specification defined in FIG. 5(d) is controllable with respect to the entire behavior of the discrete event model of FIG. 5(c). The exhaustive search over the entire grid subpart of Fig. (c) will be conducted by the SCT tool. Controllability in SCT is defined by structuring a collection of all discrete events into controllable discrete events, denoted by ¿c, and uncontrollable discrete events, denoted by Zu. Note that the entire discrete event model of the system is a disjoint union of Lu and ¿c, i.e.,

$$\sum = \sum c \sum u$$

For example, for the discrete event model of FIG. 5(a) the discrete event 2 belongs to Σᵤ as an uncontrollable event and events 1 and 3 belong to Σᵤ.

A control pattern, ζ, is formed by adjoining a subset of controllable events with all of the uncontrollable events, i.e., ζ=Σᵤ∪(a subset of Σ_{c}). The set of all possible control patterns is defined as:

$$\{ ζ \sum \vert ζ \sum u \}$$

The SCT tool will systematically generate the set [symbol] _{G}. The discrete event model for a given component may encompass both controllable and uncontrollable events. In other words, the discrete event model of a given component or grid subpart may comprise the set [symbol] _{G} for that component or grid subpart.

FIG. 5(e) shows a schematic representation of an example state machine generated based on the combined discrete event model of FIG. 5(c) and the control specification of FIG. 5(d). The state machine of FIG. 5(e), as part of the SCT-based primary controller for the MG, allows for enforcement of the control specification of FIG. 5(d) on grid subpart of FIG. 5(c).

FIGS. 5(f) and 5 (g) show schematic representations respectively of example discrete event models of another MGCB and another BESS in another MG. The other MGCB and BESS, and their associated discrete event models, may be similar to those associated with FIGS. 5(a) and 5 (b), respectively. The combined discrete event model resulting from the combinations of the discrete event models of FIGS. 5(f) and 5 (g) may be similar to the combined discrete event model shown in FIG. 5(c). FIG. 5(f) shows discrete events or transitions 4, 11, and 13. For FIG. 5(f), the order of discrete events and states are similar to that of FIG. 5(a) just for the other MGCB. For FIG. 5(g), the order of discrete events and states are similar to that of FIG. 5(b) just for the other BESS in the other MG. As such, the combined discrete event model resulting from the combination of the discrete event models of FIGS. 5(f) and 5 (g) is omitted from the drawings, for simplicity. FIGS. 5(h) and 5 (i) show schematic representations respectively of an example control specification and an example state machine, for the other MCGB and other BESS. The control specification and state machine shown in FIGS. 5(h) and 5 (i) may be functionally similar to those of FIGS. 5(d) and 5 (e) respectively.

FIG. 5(j), in turn, shows a schematic representation of a discrete event model of an example MMGCB. In FIG. 5(j), discrete events 6 and 21 represent accidental and intentional openings of the MMGCB, respectively. Discrete event 23 illustrates intentional closing of the MMGCB. The discrete states 0 and 1 represent MMGCB being in closed and open status, respectively.

FIG. 5(k) shows a schematic representation of another example control specification. The control specification of FIG. 5(k) is defined heuristically to identify the operation or behavior for the BESS in the MG and the other BESS in the other MG, depending on the status of the MMGCB, in case of one or multiple UCBs and one or multiple MGCB being open or closed. Hence, discrete events {5, 7, 9, 15, 17, 19} previously defined in models of both the BESS and the other BESS are taken into consideration in the devised control specification based on the status of the MMGCB. State 0 represents MMGCB being closed. Hence, the grid subpart is either connected to the utility if UCB is closed or disconnected as single-MG systems if MGCB is open.

Hence, discrete events {5, 7, 15, 17} are enabled to represent both operation of BESS and the other BESS in grid following mode and/or grid forming of single-MG system. If discrete event 6 or 21 occurs, implying accidental or controlled opening of MMGCB, respectively, then the system transits to State 1. The BESS and the other BESS in the MG and the other MG may operate in grid forming of multiple-MG system(s) {events 9, 19}, grid forming of single-MG system (if MGCB is open) {events 5, 15} or constant charging/discharging for the BESS or the other BESS {events 7, 17}. The transitions of discrete events {5, 7, 9, 15, 17, 19} leads the control specification of FIG. 5(k) to state (2) where the operation of the BESS and the other BESS are identified when MMGCB is open. The self loop of {5, 15, 7, 17} at state 2 indicates that upon opening of either the MGCB and/or the other MGCB, while MMGCB is open, the BESS and/or the BESS enters formation of a single-MG system or in a constant charging/discharging which is similar in definition to grid-following mode. Discrete event 23 indicates controlled closing of the MMGCB, subsequent to which discrete event 6 is enabled which represents accidental re-opening of MMGCB or discrete-events 7 and 17 implying operation of the BESS and the other BESS in grid following mode. In the meantime, discrete events 5 and 15 are self looped in both discrete states 3 and initial (marker) state 0. One reason is that, regardless of the status MMGCB, MGCB and the other MGCB identified in FIG. 5(a) and FIG. 5(f) can be open or closed.

The SCT tool can systematically check controllability of the complex control specification of FIG. 5(k) to be controllable and enforceable on the entire grid subpart of components defined in FIGS. 5(a), (b), (f), (g) and (j). Turning now to FIG. 5(l), a schematic representation is shown of an example state machine, which state machine may enforce the control specification of FIG. 5(k) on operation of the entire associated grid subpart. The discrete state 0 in the secondary controller of FIG. 5(l) illustrates MMGCB being closed and BESS and the other BESS being able to operate in grid-following mode and single-MG grid forming mode, depending on the states of MGCB and UCB. State 1 indicates opening of MMGCB and state 2 indicates if the BESS and the other BESS have entered grid-forming for multiple-microgrid system or formation for single-MG system depending on status of MGCB and the other MGCB.

FIGS. 5(a) to 5(l) illustrate examples of discrete event models, control specifications, and state machines for primary and secondary controllers. The state machine for the secondary controller (i.e. as shown in FIG. 5(l)) is generated by defining a control specification (e.g. FIG. 5(k)) that dictates behavior at a level of hierarchy higher than the control specifications (e.g. FIGS. 5(d) and (h)) associated with primary controllers. By extension, the state machine for a controller at a yet higher level of hierarchy, e.g. a tertiary controller, may be generated using another control specification defined to control or dictate behavior at a yet higher level of hierarchy, i.e. at a level higher than the control specification shown in FIG. 5(k).

The primary, secondary, and tertiary controllers can also be tested to operate in a non-blocking and non-conflicting fashion. In some examples, this testing may be performed using the SCT tool. The non-blocking feature implies that each controller within its internal operation does not get blocked and always finds a path to bring operation of the multiple-microgrid system back to desired or target state (e.g. double-circled states).

The non-conflicting feature indicates that collective operation of multiple decentralized primary, secondary, and tertiary controllers do not conflict with each other, particularly when the three controllers share discrete events of the same number. For example, the primary controller of FIG. 5(e) only permits occurrence of discrete event 7 when the controller is at state 3. However, since the discrete event 7 is permitted at all states of the secondary controller of FIG. 5(l), the primary and the secondary controllers do not conflict. The comprehensive non-conflicting test can be carried out using the SCT tool using a systematic approach for all states and transitions of the primary, secondary, and tertiary controllers.

It should also be noted that in some examples, the SCT tool may be used to generate the primary, the secondary, and the tertiary controllers with a minimum number of states and transitions at a State-Lower-Bound (SLB) to maximize execution efficiency of the control systems over hardware-software platforms.

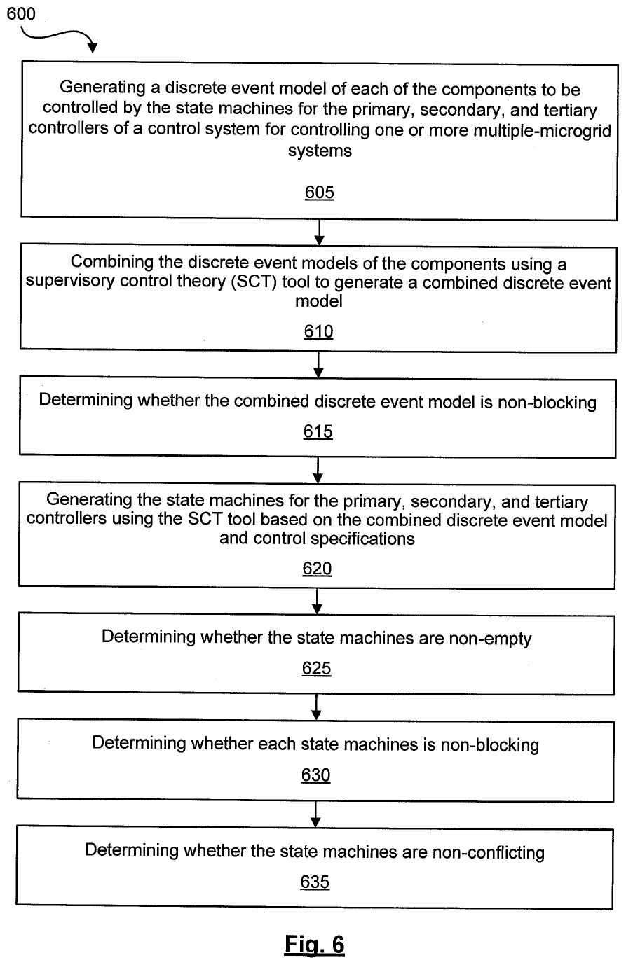

Turning now to FIG. 6, a flowchart is shown of an example method 600 for generating state machines for the primary, secondary, and tertiary controllers of the control systems described herein. At box 605 a discrete event model may be generated of each of the components to be controlled by the state machines for the primary, secondary, and tertiary controllers of a control system for controlling one or more multiple-microgrid systems.

At box 610 the discrete event models of the components may be combined using a SCT tool to generate a discrete event model. Generating this combined discrete event model may be similar to the corresponding function described in relation to box 410 of method 400. At box 615 a determination may be made as to whether the combined discrete event model is non-blocking. If the combined discrete event model is determined to be blocking, one or more of the discrete event models may be revised. For example, each discrete event for each component may be checked to ensure the discrete events in each discrete event model have unique identifiers. Examples of these identifiers may be numbers 1, 2, 3, etc. used to identify discrete events in FIGS. 5(a) to (l). In addition, each discrete event model may also be checked to ensure it is non-blocking. In some examples, such a test may be performed using the synchronous product function of the SCT tool. Once, the discrete event models are revised, then method 600 may return to box 610 to regenerate the combined discrete event model using the revised discrete event models.

If the determination at box 615 is negative, i.e. if the combined discrete event model is non-blocking, then method 600 moves to box 620. At box 620, the state machines for the primary, secondary, and tertiary controllers may be generated using the SCT tool based on corresponding control specification and the combined discrete event model. At box 625 a determination may be made as to whether each state machine is non-empty. If any of the state machines is empty, there may be an issue with the discrete event models generated in box 605 or the devised control specifications in box 620. For example, all or part of the discrete event model may be not controllable. To address the situation, method 600 may return to box 605 to generate revised discrete event models.

If there are no empty state machines at box 625, then method 600 moves to box 630. At box 630 a determination may be made as to whether each state machine is non-blocking with respect to its internal operations. In some examples, this determination may be made using the synchronous product feature of the SCT tool. If one or more of the state machines are determined to be blocking, then the corresponding control specification may be revised, and method 600 may return to box 620 to regenerate the state machine based on the revised control specification, with the aim of obtaining a non-blocking state machine. If at box 630 a determination is made that the state machines are non-blocking with respect to their internal operations, then method 600 moves to box 635.

At box 635 a determination may be made as to whether the state machines are non-conflicting. For example, a determination may be made as to whether the collective operation of the state machines powering the primary, secondary, and tertiary controllers are non-conflicting. In some examples, this determination may be made using the synchronous product feature of the SCT tool. If the determination is negative, i.e. if the collective operation is conflicting, then one or more of the control specifications may be revised and method 600 may return to box 620 to regenerate the state machines based on the revised control specifications. If the determination at box 635 is affirmative, i.e. if the collective operation of the state machines is non-conflicting, then the generated state machines may power primary, secondary, and tertiary controllers of a three-layer, hierarchical control system, such as the control systems described herein. Such control systems may be used to control electrical grids such as one or more multiple-microgrid systems.

It should be recognized that features and aspects of the various examples provided herein may be combined into further examples that also fall within the scope of the present disclosure.

1. A control system for controlling one or more multiple-microgrid systems, the control system comprising:
two or more primary controllers, each primary controller to be in communication with a corresponding microgrid (MG) and a corresponding microgrid circuit breaker (MGCB) interposed between the corresponding MG and a corresponding feeder line of a corresponding multiple-microgrid system (MMG), the MG connected to the feeder line at a point of common coupling (PCC);
a secondary controller associated with the corresponding MMG, the secondary controller to be in communication with the one or more primary controllers, the secondary controller also to be in communication with a multiple-microgrid system circuit breaker (MMGCB) interposed between the MMG and a transmission line; and
a tertiary controller to be in communication with:
the secondary controller;
one or more electrical utilities; and
one or more utility circuit breakers (UCBs) each corresponding to one of the one or more utilities, each UCB interposed between the corresponding utility and the transmission line.

2. The control system of claim 1, further comprising:
a further secondary controller associated with a further corresponding MMG, the further secondary controller to be in communication with one or more further primary controllers associated with the further corresponding MMG, the further secondary controller also to be in communication with a further multiple-microgrid system circuit breaker (further MMGCB) interposed between the further MMG and the transmission line; and
wherein:
the tertiary controller is to be in communication with the further secondary controller.

3. The control system of claim 1, wherein the secondary controller is further to receive measurements of one or more operational parameters measured at the PCC.

4. The control system of claim 3, wherein the operational parameters comprise one or more of voltage, current, and frequency in the feeder line at the PCC.

5. The control system of claim 1, wherein one or more of the MGs each comprise one or more of a source to generate electrical energy, a load to consume electrical energy, and a battery energy store system (BESS) to store or release electrical energy.

6. The control system of claim 5, wherein one or more of the primary controllers, the secondary controller, and the tertiary controller comprise processing hardware to execute machine-readable instructions embodying a state machine.

7. The control system of claim 6, wherein the processing hardware comprises a programmable logic controller (PLC).

8. The control system of claim 6, wherein the state machine is based on a discrete event model of one or more of: the one or more MGs, the one or more MGCBs, the MMG, the MMGCB, the one or more electrical utilities, and the one or more UCBs.

9. The control system of claim 8, wherein:
the state machine is associated with one of the primary controllers associated with the corresponding MG; and
the state machine covers all possible events in the discrete event model of the corresponding MG.

10. The control system of claim 5, wherein:
when a given MGCB is open:
the primary controller associated with the given MGCB is to control a given MG associated with the given MGCB by controlling one or more of the source, the load, and the BESS associated with the given MG; and
the secondary controller and the tertiary controller do not participate in controlling the given MG.

11. The control system of claim 1, wherein:
when two or more given MGCBs are closed and the associated given MMGCB is open, the secondary controller associated with the given MMGCB is to:
control the given primary controllers associated with the two or more given MGCBs to coordinate the operation of the given primary controllers; and
receive measurements of operational parameters measured at the PCC.

12. The control system of claim 1, wherein:
when two or more given MGCBs are closed, the associated given MMGCB is closed, and the one or more UCBs are open:
the secondary controller associated with the given MMGCB is to:
control the given primary controllers associated with the two or more given MGCBs; and
receive measurements of operational parameters measured at the PCC; and
the tertiary controller is to:
dictate one or more of the operational parameters at the PCC.

13. The control system of claim 1, wherein:
when two or more given MGCBs are closed, the associated given MMGCB is closed, and one or more of the UCBs are closed:
the tertiary controller is to:
receive utility operating parameters from one or more of the utilities associated with the closed UCBs;
communicate the utility operating parameters to the secondary controller; and
dictate one or more of the operational parameters at the PCC; and
the secondary controller associated with the given MMGCB is to:
control the given primary controllers associated with the two or more given MGCBs; and
receive measurements of operational parameters measured at the PCC.

14. The control system of claim 2, wherein:
when two or more given MGCBs are closed, the associated given MMGCB is closed, the further MMGCB is closed, and the one or more UCBs are open:
the secondary controller associated with the given MMGCB is to:
control the given primary controllers associated with the two or more given MGCBs; and
receive measurements of operational parameters measured at the PCC;
the further secondary controller is to:
control the given further primary controllers associated with the further corresponding MMG; and
receive measurements of the operational parameters measured at the PCC;
the tertiary controller is to:
control the secondary controller and the further secondary controller to coordinate the operation of secondary controller and the further secondary controller; and
dictate one or more of the operational parameters at the PCC.

15. The control system of claim 2, wherein:
when two or more given MGCBs are closed, the associated given MMGCB is closed, the further MMGCB is closed, and one or more of the UCBs are closed:
the tertiary controller is to:
receive utility operating parameters from one or more of the utilities associated with the closed UCBs;
communicate the utility operating parameters to the secondary controller and the further secondary controller;
control the secondary controller and the further secondary controller; and
dictate one or more of the operational parameters at the PCC;
the secondary controller associated with the given MMGCB is to:
control the given primary controllers associated with the two or more given MGCBs; and
receive measurements of operational parameters measured at the PCC;
the further secondary controller is to:
control the given further primary controllers associated with the further corresponding MMG; and
receive measurements of the operational parameters measured at the PCC.

16. A method of generating the state machine for one or more of the primary controller, the secondary controller, and the tertiary controller of the control system of claim 6, the method comprising:
generating a discrete event model of each of the components to be controlled by the state machine;
combining the discrete event models of the components using a supervisory control theory (SCT) tool to generate a combined discrete event model;
generating a control specification associated with the control of the components by the state machine;
generating the state machine using the SCT tool based on the combined discrete event model and the control specification; and
outputting the state machine.

17. The method of claim 16, further comprising:
before the generating the state machine:
determining, using a synchronous product function of the SCT tool, whether the combined discrete event model is non-blocking; and
if the determination is negative:
generating a revised discrete event model of one or more of the components; and
regenerating the combined discrete event model using the SCT tool based on the revised discrete event model.

18. The method of claim 16, further comprising:
before the outputting the state machine:
determining whether the state machine is empty; and
if the determination is affirmative:
generating a revised discrete event model of one or more of the components;
generating a revised combined discrete event model using the SCT tool based on the revised discrete event model; and
regenerating the state machine using the SCT tool based on the revised combined discrete event model and the control specification.

19. The method of claim 16, further comprising:
before the outputting the state machine:
determining, using a synchronous product function of the SCT tool, whether the state machine is non-blocking; and
if the determination is negative:
generating a revised control specification associated with the control of the components; and
regenerating the state machine using the SCT tool based on the combined discrete event model and the revised control specification.

20. The method of claim 16, further comprising:
generating another discrete event model of each of corresponding components to be controlled by another state machine, the other state machine for another one of the one or more of the primary controller, the secondary controller, and the tertiary controller of the control system of claim 6;
combining the other discrete event models of the corresponding components using the SCT tool to generate another combined discrete event model;
generating another control specification associated with the control of the corresponding components by the other state machine;
generating the other state machine using the SCT tool based on the other combined discrete event model and the other control specification;
determining, using a synchronous product function of the SCT tool, whether the state machine is non-conflicting with the other state machine; and
if the determination is negative, one or more of:
generating a revised control specification; and
generating a revised other control specification.
